(19) United States
(12) Patent Application Publication
(10) Pub. No.: US 2014/0025187 A1
(43) Pub. Date: Jan. 23, 2014

(54) Knowledge Quest Game Platform & Experience

(71) Applicants: Julie Barrier, Los Angeles, CA (US); John B. Rodgers, Malvern, PA (US)

(72) Inventors: Julie Barrier, Los Angeles, CA (US); John B. Rodgers, Malvern, PA (US)

(73) Assignee: SAP AG, Walldorf (DE)

(21) Appl. No.: 13/555,896

(22) Filed: Jul. 23, 2012

(51) Int. Cl. G06F 19/00

(52) U.S. Cl. 700/91

(57) ABSTRACT

A method, a system, and a computer program product for enhancing user experience at large scale events are disclosed. User-related information from a user is obtained from the user. A list of activities designed specifically for the user to perform is generated based on the obtained user-related information. At least one activity contained in the generated list of activities is performing using a computing device of the user. A result based on the at least one performed activity is generated. A predetermined value is assigned to the generated result. The generated results for all performed activities on the list of activities is accumulated.

### TECHNICAL FIELD

This disclosure relates generally to data processing and, in particular, to enhancing user experience at large scale events.

### BACKGROUND

Conventions, exhibitions, or other large scale type events are typically meetings or gatherings of a significant number of individuals that meet at an arranged place and time in order to discuss or engage in various common interest activities or events. Sometimes, conventions are based upon industry, profession, and/or fandom. Trade conventions can typically focus on a particular industry or industry segment(s). Such conventions can feature keynote speakers, vendor displays (e.g., exhibitor booths), and other information and activities of interest to event organizers and attendees. Professional conventions can focus on issues of concern to a particular profession and/or advancements in the profession. These types of conventions can be organized by societies that are dedicated to serving such professions/industries. Other types of conventions can include fan conventions that can feature displays, shows, and sales based on pop culture and guest celebrities; science fiction conventions that can include both professional conventions and fan conventions; hobbies-based conventions, e.g., gaming or model railroads. Most conventions are large-scale events that can involve a substantial number of organizers and/or support staff and can be attended by thousands of participants/attendees. They can also have a significant number of exhibitors, keynote speakers, as well as other individuals/entities participating in the conventions. An example of such large-scale event is an SAP TechEd event that was held in September 2011 in Las Vegas, Nev.

Conventions can be often planned and coordinated by professional meeting and convention planners, either by staff of the convention's hosting company or by outside specialists. Conventions are typically held at convention centers that can be specifically dedicated to hosting such events.

Conventions can be overwhelming and even intimidating to organizers, supporters, and/or attendees as there are a significant amount of content/knowledge that is being presented for absorption and a large number of people attending. It is sometimes difficult for the attendees of such conventions to sift through all the information and/or materials that is being presented and organize themselves for the purposes of providing a personal, meaningful, and memorable experience. Periodically, attendees do not know how to network and/or engage with other attendees at such conventions and given the amount of content presented at conventions, are left on their own to navigate through the abundance of information. As a result, attendees do not realize the full benefits of the convention experience.

### SUMMARY

In some implementations, the current subject relates to a method for enhancing user experience at large scale events. User-related information can be obtained from a user. Based on the obtained user-related information, a list of activities designed specifically for the user to perform can be generated. Using a computing device of the user, at least one activity contained in the generated list of activities can be performed. A result based on the at least one performed activity can be generated. A predetermined value to the generated result can be assigned. The generated results for all performed activities on the list of activities can be accumulated. At least one of the obtaining, the generating the list of activities, the generating the result, the assigning, and the accumulating can be performed on at least one processor.

In some implementations, the current subject matter can include one or more following optional features. The generating of the list of activities can include generating, based on the obtained user-related information, at least one keyword indicative of at least one interest of the user, searching, using the at least one generated keyword, a database of activities, matching at least one activity contained in the database of activities with the at least one generated keyword, and generating the list of activities, wherein the list of activities contains activities matching the at least one generated keyword.

The activity can include a challenge for the user to answer. In some implementations, a first predetermined value can be assigned for participation of the user in the activity and a second predetermined value can be assigned for the user's answer to the challenge included in the activity. The generated result can include user's answer to the challenge included in the activity. The assigned predetermined value can be a sum of the first predetermined value and the second predetermined value.

The number of activities in the generated list of activities can be limited.

The method can further include performing at least one activity that is not contained on the generated list of activities, wherein no value is assigned for a result generated based on the performed activity not contained on the generated list of activities.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary floor disposition for an event, according to some implementations of the current subject matter.

FIG. 2 illustrates an exemplary computing system for an event, according to some implementations of the current subject matter.

FIG. 3 illustrates an exemplary list of activities generated for an attendee, according to some implementations of the current subject matter.

FIG. 4 illustrates an exemplary system, according to some implementations of the current subject matter.

FIG. 5 illustrates an exemplary method, according to some implementations of the current subject matter.

### DETAILED DESCRIPTION

To address these and potentially other deficiencies of currently available solutions, one or more implementations of the current subject matter provide methods, systems, articles or manufacture, and the like that can, among other possible advantages, provide systems and methods for providing systems, methods, and computer program products for providing an enhanced experience to an attendee of a large-scale event or convention.

As stated above, conventions or other large-scale events can have a significant number of attendees (e.g., hundreds, thousands, etc.) that come to such events to participate in various activities, gain knowledge and experience, develop and/or generate business, meet other individuals, etc. Event activities can include educational sessions and/or presentations that are presented to a group of attendees by a presenter, where the attendees can sign up to participate in a session, be specifically invited by the presenter, and/or attend such session based on any other condition(s). Events can also include exhibition halls, where a plurality of exhibitors can present their products and/or services to attendees for demonstration, purchase, and/or for any other purpose(s). Events can also include various other activities, e.g., video demonstrations, testing centers, and/or any others.

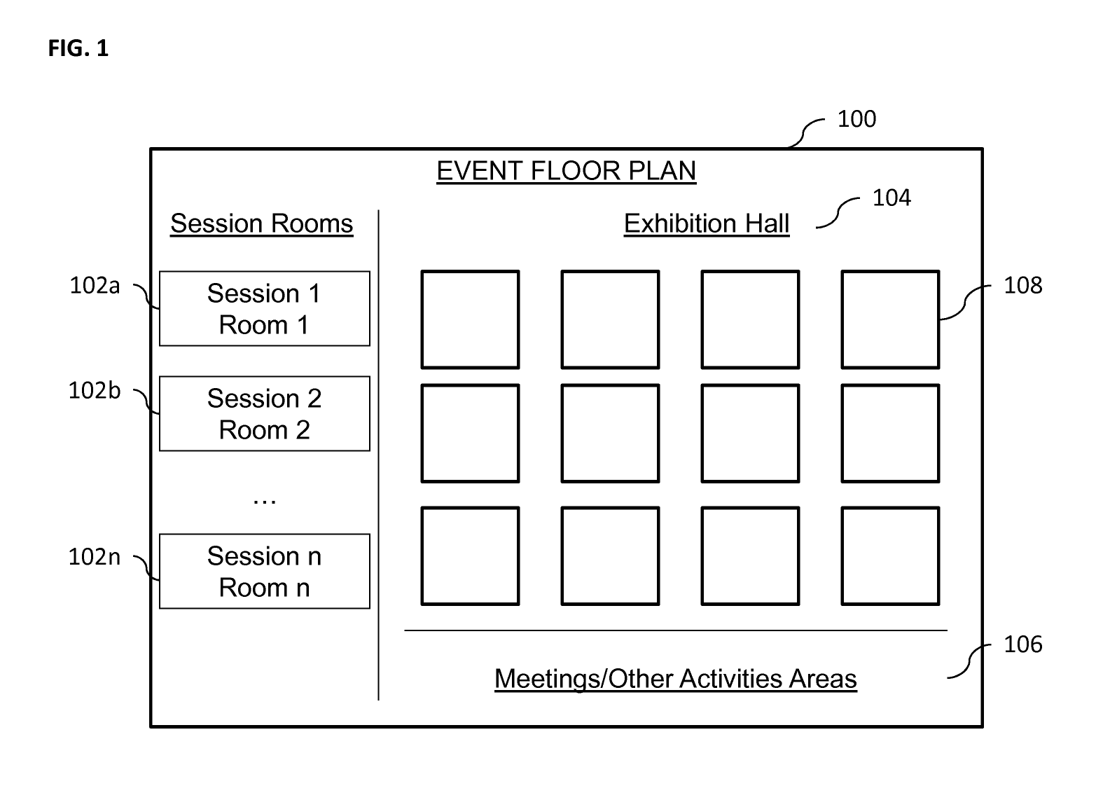

In some implementations, events can be held at a convention center that can be selected based on the size, type, subject matter, etc. of the event. In addition to attendees, events can have event organizers along with various staff that can support the event and assist the attendees. The organizers can design a floor plan for the event to be held a convention center, where the floor plan can designate where each particular event activity is to be held. FIG. 1 illustrates an exemplary floor plan 100 for an event. The event can include sessions 102a, 102b, . . . , 102n, etc., each of which can gather a predetermined number of attendees. The sessions 102 can include a presenter discussing various topics of interest. The event can also have an exhibition hall 104, where a plurality of exhibitors can present their products and/or services at exhibitor booths 108. The event can also have other activities area 106, which can include a meeting area, a video presentation center, a testing center, an information booth, a concession stand, event organizers' offices, etc. The event can include various other activities that can be engaged by the attendees of the event.

In some implementations, events can be held online, where attendees participate in various activities using a network (e.g., an Internet, a wide area network (WAN), local area network (LAN), metropolitan area network (MAN), and/or any other network). Activities and types of activities can be similar or different to those of an event that is held at a convention center.

Events can be held at a convention center and online. In this case, attendees can participate in activities while at a physical location in the convention center and/or online via a network. Attendees participating via a network can participate while they are in the convention center and/or at another location (e.g., office, home, café, etc.) that separate from the convention center.

In some implementations, to enhance attendees' participation as well as learning, interaction, and other experience, event activities can be assigned various point values which the attendees can earn by participating in such activities. If the event is held over a course of few days, the earned point values can be accumulated to generate a total value of points earned during the event. The total value of points earned can correspond to a predetermined prize that an attendee can receive. Such point reward system can stimulate attendee's participation in various event activities.

The point values can be determined based on a type of activity and/or level of attendee's participation. For example, if attendee participates in a particular session where a presentation on a specific topic is given, the attendee can receive X number of points. If the attendee answers various questions at the end of the session, the attendee can receive Y number of points, where Y can be greater than X. If the attendee answers all questions that are posed at the end of the session correctly, the attendee can receive Z number of points, where Z can be greater than Y. If some questions are not answered correctly, the attendee can receive less than the highest number of points that can be given to the attendee if the attendee answers all questions correctly. Further, if an attendee visits an exhibitor's booth of a particular vendor in the exhibition hall, the attendee can receive a predetermined number of points. If that attendee participates in some form of an activity offered by the vendor, the attendee can also receive additional number of points. The event organizers can also provide various activities (e.g., scavenger hunt, team-building, etc.) that may be worth various predetermined number of points.

Further, each activity can have a different weight assigned to it when a total is calculated. For example, participation in a session and answering questions offered by the presenter of the session can have a greater weight value than visiting an exhibitor's booth. To prevent, attendees from participating only in the high-point value activities, the number of activities in which attendee can participate during a day of the event can be limited to a predetermined number (e.g., four sessions, four visits to the exhibitors' booths, four other activities). This way, the attendee can have a meaningful and learning experience at the event.

In some implementations, the attendees can be organized into teams and be given a specific assignment that can contain a certain activity or a number of activities for the team to participate in. Such team-based activities can be worth a predetermined number of points, where the point values can be higher than point values for activities participated by attendees on their own. The total point values earned for individually-participated activities and/or team-based activities can be added together to generate a total for each particular attendee during the entire event to allow the attendee to earn a prize. In some implementations, the points values earned for participation in individual and team-based activities can be summed up separately.

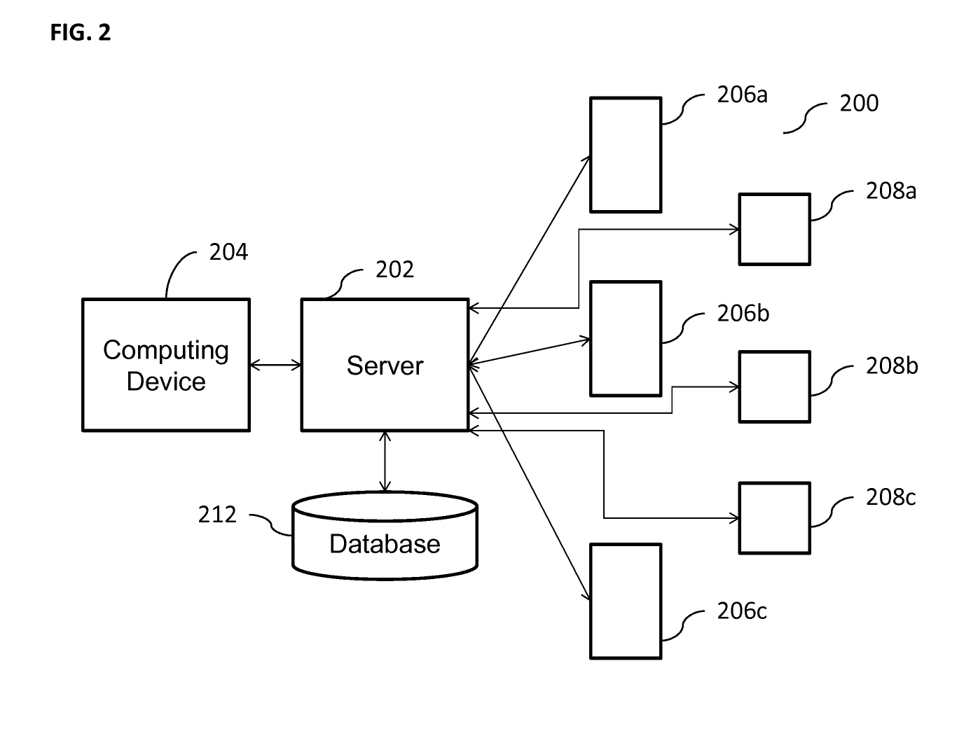

FIG. 2 illustrates an exemplary computer system 200 that can provide an enhancing attendee experience at a large scale event, according to some implementations of the current subject matter. The system 200 can be set up in a convention center where the large scale event takes place or otherwise can be set up remotely from the convention and can communicate with various components that can be implemented in providing such enhancing experience for attendees. The system 200 can include a server 202 that can provide communication between a system device 204 and a plurality of event supporting devices 206 (a, b, c), which in turn, communicate with attendee devices 208 (a, b, c). The system 200 can also include a database 212 that can store information about the event, attendees, vendors, activities that are offered at the event for attendees, as well as any other information related to the event. The server 202 can communicate with the database 212 to search the database for retrieval of various information, to store information provided by the attendees, the event organizers, and/or any others, to backup any data that the sever 202 receives, and/or for any other purposes. The device 204, 206, and 208 can be stationary personal computers, laptops, mobile devices, telephones, mobile telephones, personal digital assistants (“PDA”), smartphone devices, scanners, printers, and/or various other devices and/or various combinations thereof. The components 202, 204, 206, and 208 can communicate with one another via at least one network that can be set up between these devices. Such network can be wireless, wired, LAN, MAN, WAN, and/or any other type network.

In some implementations, the attendees, presenters, vendors, and/or any other providers of activities at the event can register with the system 200 either before the beginning of the event and/or during the event by providing information about them. The information can include name, address, company name, and in cases of activity providers, a type of activity that will be provided at the event (e.g., session, exhibitor's booth), type of product/service being offered, details about the activity (e.g., a list of questions for attendees participating in a session, details about a particular product that a vendor of that product wishes to convey to the attendee, etc.), as well as any other information. The event organizers can gather the provided information, organize the provided information into various groups, generate a potential list of activities for attendees and/or groups of attendees (e.g., sign up for a session, attend an exhibitor's booth, participate in a networking session, view a promotional video, conduct a survey of a product/service, go on a scavenger hunt (e.g., to find a particular product, information, etc.), participate in a team-building exercise, etc.) determine point values for each activity, assign weight values for each activity, determine various limits on a number of activities that attendees can participate during a day and/or during the entire event, determine prizes that the attendees can receive, etc. In some implementations, the attendee can self-select a list of activities that the attendee wishes to participate in without being provided with the list of suggested activities. The attendee can select activities based on various criteria, such as, for example, personal interests, professional interests, requirements of attendee's organization, as well as any other criteria. The attendee can build attendee's own agenda for a portion of the event (e.g., half a day, a day, two days, etc.) and/or for the entire duration of the event. In some implementations, the attendee and the event organizers can build the attendee's agenda together.

Referring back to FIG. 2, the event devices 206 can be set up at particular locations in the convention center and can be assigned to each particular activity, e.g., a session, an exhibitor's booth, a networking activity, etc. For example, an event device 206 can be installed at an exhibitor's booth and can provide a way for the attendee and the vendor to interact with one another and to record such interactions (e.g., the attendee reviews vendor's product). An event device can be installed at a session, where a presenter gives a presentation on a particular topic and after the presentation, the event device can generate question(s) for the session attendees to answer. The questions can be prepared by the presenter in advance or randomly generated by the computer based on the subject matter of the presentation. Each question can have a point value assigned to it, whereby an attendee correctly answering the question can earn such point value. Similarly, event devices 206 can be installed at any other activities. When an attendee decides to participate in a particular activity (e.g., session, exhibitor's booth, etc.), the attendee can register with the event device by providing attendee's identification information to the event device 206. The identification information can be a unique ID number that is assigned to the attendee when the attendee registers with the event. The identification information can be provided to the event device 206 by the attendee directly entering the information into to the device 206, scanning attendee's badge (which can be provided to the attendee and that can contain attendee's information in a bar-coded form, magnetic form, and/or any other form) at the device 206. When the attendee registers with the device 206, the device 206 can forward such information to the server 202 indicating that the attendee has registered with a particular activity with which the device 206 has been associated. The server 202 can then send an appropriate notification to the computer 204, which can have a processor and a memory and can track all registrations and activity participations. The computer 204 can be monitored by the event organizers.

Once the attendee has registered or “signed on” to the activity, the attendee can participate in it (e.g., listen to the session, examine vendor's product, etc.). Upon completion of the activity, the attendee can be presented with an appropriate challenge (e.g., question(s) at the end of the session, completion of a survey, etc.). Correctly answering the challenge can result in points being given to the attendee. When attendee activity (e.g., reviewing a product at vendor's booth, answering a question at the end of a session, etc.) is detected by the event device 206, the device 206 can forward the information associated with the attendee and attendee's actions in relation to the activity to the server 202 for processing and storage. The server 202 can keep track of attendee's activities and accumulated points. The server 202 can also calculate points based on the activity and appropriate weights associated with activities.

In some implementations, the attendees can carry with them mobile devices 208, which can directly communicate with the server 202 (e.g., via a wireless network) and that can be used for registration with the system 200 and/or particular activities. For example, an attendee carrying the device 208 can select a group of activities from a menu of options presented on the device 208, then select a particular activity from the group of activities and register to participate in that activity. Once the attendee registered to participate in a specific activity, an appropriate indication is sent to the server 202 to alert the server that the attendee intends to participate in the activity and has used his/her device 208. At the conclusion of the activity, the attendee can be presented with a challenge associated with the activity on the attendee's device 208. The attendee can use the device 208 to answer the challenge. Once the challenge is answered, the answer is sent to the server 202 for processing. Further, the server 202 can assign point values to the attendee's answer and can calculate the total value of the points earned by the attendee. All of the above information can be stored by the server 202 in the database 212 and/or any other storage. In some implementations, the attendee is not advised of the total number of points earned for each activity and/or during each day of the event. In some implementations, the attendee can be provided with the information as to how many points the attendee earned in one day and/or throughout the entire event. In some implementations, the number of points earned (whether in one day and/or so far and/or for the entire event) by other attendees can be hidden from the attendee. In some implementations, the event organizers can display a list of top performers (e.g., attendees that have earned the highest number of points) for a given day (and/or any portion) of the event. In some implementations, if the attendee does not see his/her name in the list of top performers, the attendee's point-standing as compared to other attendees may be hidden. Further, the number of activities in which an attendee can participate can be limited by each particular type of activity. Once the limit is reached, the attendee can be appropriately advised that the limit on the number of particular activities in a group of activities has been reached and that attendee's participation in other activities in the same group of activities will not earn attendee any additional points. However, the attendee can choose to participate in such activities regardless of whether limit on the number of activities has been reached.

In some implementations, the attendee, upon registering with the event, can create a profile on a website of the event (which can be setup by the event organizers) using attendee's registration email and/or any other information that is related to the attendee. The information can include attendee's name, address, company name, products/services offered by the company, attendee's interests, attendee's company interests, as well as any other pertinent information. Based on the attendee's entered information, attendee can be provided with a list of potential activities (e.g., sessions, exhibitor's booths, games, etc.) that attendee can participate in. Such list can be provided by the server 202. The server 202 can use various keywords in the attendee's entered information to match such information with information contained in the database 212. Once the matching information is found in the database 212, the server 202 can retrieve the found information and provide it to the attendee in an appropriate format. In some implementations, the attendee can self-select the activities that the attendee wishes to participate in and provide that to the server 202.

The server 202 can also track attendee's participation in various activities (e.g., type of activity, number of activities, etc.) and store information associated with such tracking in the database 212. For example, upon attendee participating in a session of interest (whether or not such session is suggested to the attendee by the server 202 upon registration), the attendee can be awarded a certain number of reward points. Further, upon answering questions at the end of the session, the attendee can be also awarded additional reward points. Upon receiving an indication that the attendee registered/attended the session and answered questions at the end of the session from the devices 206 and/or 208, both sets of points can be recorded by the server 202 and stored in the database 212. The attendee can request the server 202 (via the device 206 and/or 208) to provide information to the attendee about the activities participated as well as the number of points awarded. In some implementations, the number of points awarded can be kept secret from the attendee until the end of a particular day of the event, the end of the entire event, upon attendee's decision to terminate attendee's participation in the event, upon attendee's being expelled from the event, and/or for any other reason.

In some implementations, the attendees can participate in event's activities (sessions, exhibitor's booths, games, etc.) individually and/or in teams. For example, during some days of the event and/or during a predetermined number of hours in a given day, the attendees can be given an opportunity to form an ad-hoc team and/or organized into teams (based on various parameters, e.g., common interests, common prior activities participated, etc.) in order to participate in an activity (e.g., scavenger hunt challenge) for the purposes of networking as well as earning more reward points. While attendees can participate in such activity individually, participation in a team can earn a higher amount of points (e.g., double).

The following illustrates some of the exemplary activities that an attendee of an event can participate in, according to some implementations of the current subject matter. As stated above, the activities are designed to enhance attendee's experience at the event while providing an opportunity to network with other attendees as well obtain knowledge that is of interest to the attendee. The attendee can select any of these activities using attendee's device 208 or device 206. The activities can be selected from a list of activities that the server 202 can generate and provide to the attendee based on the information that attendee has provided to the server 202 (or alternatively, the attendee can self-select). The list of activities can be displayed on the attendee's device 208 (or device 206 upon attendee logging into the device 206). The attendee can then select a particular activity of interest.

In some implementations, the activities can include keynote questions that are related to a particular session that the attendee can attend. The questions can be a priori written by the session presenters, event organizers and/or any others. The answers can be in multiple-choice form, and attendees must attend each keynote session in order to answer the questions. The questions can appear on the event's website on the day following each keynote session. The attendees can be asked, for example, to answer questions about key themes and information gathered from the keynote session. Attendance at the keynote session can be worth a predetermined number of reward points. Answering questions can be worth additional points and answering them correctly can be worth even more additional points. Attendee's attendance and answers to questions can be entered on the device 206 and/or 208 and recorded by the server 202 in the database 212.

In some implementations, the activities can include session surveys, where attendees can be asked and rewarded for completing feedback surveys from each session. The feedback surveys can be structured as multiple choice questions asking attendees to rank various aspects of the session(s) (e.g., rate usefulness of the presented information, rate presenters' ability to convey information, etc.). An extra field can be provided for open-ended comments. For example, up to ten specific feedback questions and one open-ended survey field can be provided to attendees at each such session. Similarly, attendance at the sessions can be worth a predetermined number of reward points to the attendees. Answering survey questions can be worth additional points and providing further feedback can be worth more additional points. Attendee's attendance and answers to survey questions can be entered on the device 206 and/or 208 and recorded by the server 202 in the database 212. The survey questions (and/or format of the survey) can also be prepared a priori by the presenters and/or event organizers.

In some implementations, the activities can also be related to a session and can include session multiple choice questions, where the questions can be provided by the session presenter and can seek to reinforce learning from the session by emphasizing various skills and information as determined by session presenters. For example, the session presenters can submit session questions to the event organizers in a form of multiple-choice questions at a predetermined time prior to the session. The attendees can be presented with the questions on the devices 206 and/or 208 and be prompted to respond using these devices. The attendees' participation in the session, their answers, as well as points earned is recorded by the server 202 and stored in the database 212.

In some implementations, the activities can include head-to-head challenges, which can include daily interactions that are designed to be fun and light-hearted, thereby getting the attendees to interact with one another and encourage further networking. These activities can ask the attendees to assemble into teams in a predetermined location (either at the event facilities or outside the event facilities) and perform various tasks, solve challenges, generate various work product, etc. For example, the challenge can be a “Compliment Duel!”, whereby an attendee finds another attendee for a compliment duel and compliment him/her until one of them falters, thereby losing the duel. Number of compliments as well as who falters first can be recorded on the devices 206 and/or 208 and provided to the server 202 for storing in the database 212. Another example can include “Hi-Tech Weigh-Off!” challenge, whereby all of attendee's electronic devices are weighed together and compared with a total weight of another attendee's electronic devices, where the attendee with the higher weight wins the challenge.

In some implementations, the activities can include exhibitor interactions, where an attendee can visit a particular exhibitor's booth (either as suggested to the attendee by the event organizers via server 202 or randomly walking through the event facilities). Exhibitors can submit questions targeted to attendees based on specific tracks/interests. When attendees visit the exhibitor's booth, the exhibitor can prompt the attendee to answer a trivia question, fill out a feedback survey, or enter a code provided by the exhibitor. In some implementations, the attendees can be limited in the number of exhibitor's booths they can visit for which reward points can be granted, but the attendees are not prevented from visiting other booths. Attendee's visit to the exhibitor's booth as well as answering exhibitor's challenge (e.g., trivia question, survey, etc.) can be recorded using devices 206 and/or 208 and provided to the server 202 for storage in the database 212.

In some implementations, the activities can include interactive station challenges. Such stations can be dispersed throughout the event's facilities and the attendees can approach such stations to answer specific questions that can be provided by the station. The attendees can use the station to answer the questions presented or use their devices 208. Attendee's answers can be rewarded with a predetermined number of reward points. In some implementations, the number of stations that the attendee can visit and earn points can be limited, but the attendee can visit as many stations as possible without earning points after the limit has been reached. Each interactive station can pose questions that can test specific expert knowledge of the attendee, where the questions are prepared by an expert in a particular field being tested.

In some implementations, the activities can include group challenges, where attendees can form ad-hoc groups or be informed that they are part of a specific group of attendees in order to solve a particular problem, puzzle, and/or challenge. The groups can be asked to do so at the event's facilities or outside. For example, the challenges can include location-based scavenger hunt missions, and/or challenges that require a photograph (e.g., “find three other attendees from other companies/countries and take a photo of the four of you with your badges clearly visible”). In some implementations, the activities can also include trivia questions (e.g., “What is your company's president name?”) for which the attendees can earn points (whether or not they answer those questions correctly).

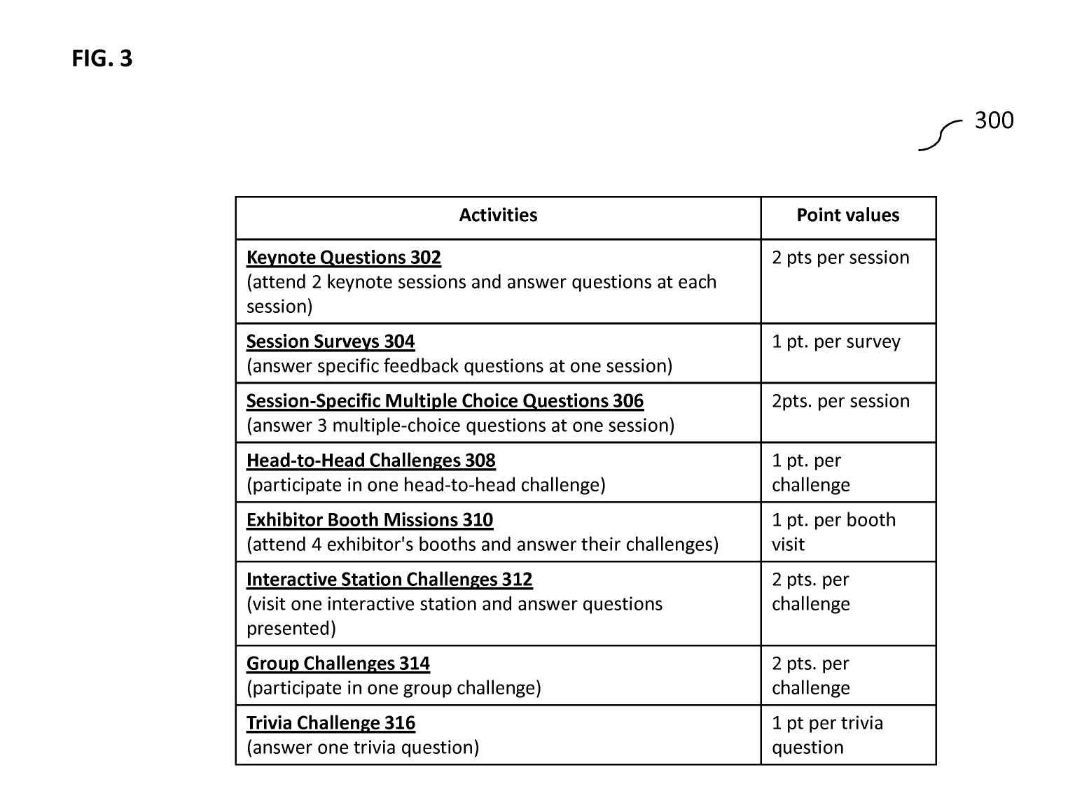

FIG. 3 illustrates an exemplary list of activities 300 that can be provided to the attendee based on attendee's information. The number of activities in each category of activities for which an attendee can earn points can be limited. The list 300 includes keynote questions 302 (attend 2 keynote sessions and answer questions at each session), session surveys 304 (answer specific feedback questions at one session), session-specific multiple choice questions 306 (answer 3 multiple-choice questions at one session), head-to-head challenges 308 (participate in one head-to-head challenge), exhibitor booth missions 310 (attend 4 exhibitor's booths and answer their challenges), interactive station challenges 312 (visit one interactive station and answer questions presented), group challenges 314 (participate in one group challenge), and trivia questions 316 (answer one trivia question). As stated above, the activities 302-316 can be provided to the attendee based on the information submitted by the attendee. In some implementations, the attendee can be optionally provided with a number of reward points that can be awarded for each specific activity, as shown in FIG. 3. In some implementations, the number of reward points and a total accumulated by the attendee can be hidden from the attendee during attendee's participation in the event.

At the end of the event, each attendee's points earned as a result of the attendee's activities at the event are totaled. Based on the calculated totals, winners can be determined and prizes awarded. In some implementations, a total number of points for all attendees can be calculated and based on that total, the event organizers can also award a prize in a form of a donation to a charitable organization.

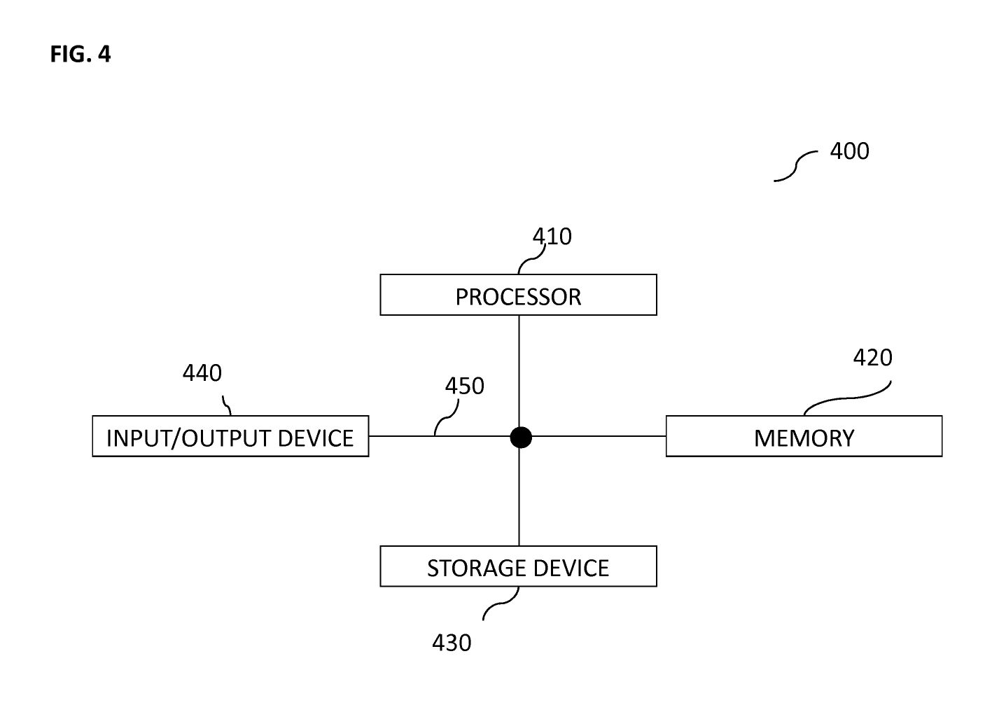

In some implementations, the current subject matter can be configured to be implemented in a system 400, as shown in FIG. 4. The system 400 can include a processor 410, a memory 420, a storage device 430, and an input/output device 440. Each of the components 410, 420, 430 and 440 can be interconnected using a system bus 450. The processor 410 can be configured to process instructions for execution within the system 400. In some implementations, the processor 410 can be a single-threaded processor. In alternate implementations, the processor 410 can be a multi-threaded processor. The processor 410 can be further configured to process instructions stored in the memory 420 or on the storage device 430, including receiving or sending information through the input/output device 440. The memory 420 can store information within the system 400. In some implementations, the memory 420 can be a computer-readable medium. In alternate implementations, the memory 420 can be a volatile memory unit. In yet some implementations, the memory 420 can be a non-volatile memory unit. The storage device 430 can be capable of providing mass storage for the system 400. In some implementations, the storage device 430 can be a computer-readable medium. In alternate implementations, the storage device 430 can be a floppy disk device, a hard disk device, an optical disk device, a tape device, non-volatile solid state memory, or any other type of storage device. The input/output device 440 can be configured to provide input/output operations for the system 400. In some implementations, the input/output device 440 can include a keyboard and/or pointing device. In alternate implementations, the input/output device 440 can include a display unit for displaying graphical user interfaces.

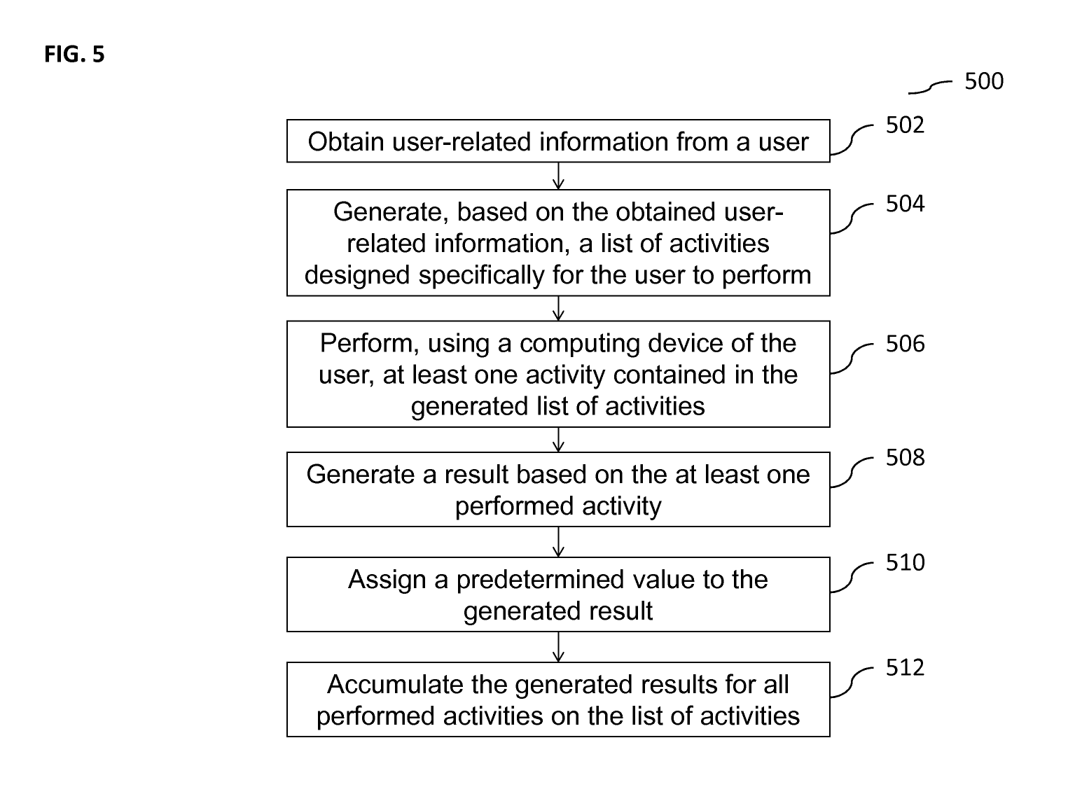

FIG. 5 illustrates an exemplary method 500, according to some implementations of the current subject matter. At 502, user-related information can be obtained from a user. At 504, based on the obtained user-related information, a list of activities designed specifically for the user to perform can be generated. At 506, using a computing device of the user, at least one activity contained in the generated list of activities can be performed. At 508, a result based on the at least one performed activity can be generated. At 510, a predetermined value to the generated result can be assigned. At 512, the generated results for all performed activities on the list of activities can be accumulated. At least one of the obtaining, the generating the list of activities, the performing, the generating the result, the assigning, and the accumulating can be performed on at least one processor.

In some implementations, the current subject matter can include one or more following optional features. The generating of the list of activities can include generating, based on the obtained user-related information, at least one keyword indicative of at least one interest of the user, searching, using the at least one generated keyword, a database of activities, matching at least one activity contained in the database of activities with the at least one generated keyword, and generating the list of activities, wherein the list of activities contains activities matching the at least one generated keyword.

The activity can include a challenge for the user to answer. In some implementations, a first predetermined value can be assigned for participation of the user in the activity and a second predetermined value can be assigned for the user's answer to the challenge included in the activity. The generated result can include user's answer to the challenge included in the activity. The assigned predetermined value can be a sum of the first predetermined value and the second predetermined value.

The number of activities in the generated list of activities can be limited.

The method can further include performing at least one activity that is not contained on the generated list of activities, wherein no value is assigned for a result generated based on the performed activity not contained on the generated list of activities.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
obtaining user-related information from a user;
generating, based on the obtained user-related information, a list of activities designed specifically for the user to perform;
performing, using a computing device of the user, at least one activity contained in the generated list of activities;
generating a result based on the at least one performed activity;
assigning a predetermined value to the generated result; and
accumulating the generated results for all performed activities on the list of activities;
wherein the at least one of the obtaining, the generating the list of activities, the generating the result, the assigning, and the accumulating is performed on at least one processor.

2. The method according to claim 1, wherein the generating the list of activities further comprises
generating, based on the obtained user-related information, at least one keyword indicative of at least one interest of the user;
searching, using the at least one generated keyword, a database of activities;
matching at least one activity contained in the database of activities with the at least one generated keyword; and,
generating the list of activities, wherein the list of activities contains activities matching the at least one generated keyword.

3. The method according to claim 1, wherein the activity includes a challenge for the user to answer.

4. The method according to claim 3, wherein a first predetermined value is assigned for participation of the user in the activity and a second predetermined value is assigned for the user's answer to the challenge included in the activity, wherein the generated result includes user's answer to the challenge included in the activity.

5. The method according to claim 4, wherein the assigned predetermined value is a sum of the first predetermined value and the second predetermined value.

6. The method according to claim 1, wherein the number of activities in the generated list of activities is limited.

7. The method according to claim 1, further comprising
performing at least one activity that is not contained on the generated list of activities, wherein no value is assigned for a result generated based on the performed activity not contained on the generated list of activities.

8. A computer program product comprising a machine-readable medium storing instructions that, when executed by at least one programmable processor, cause the at least one programmable processor to perform operations comprising:
obtaining user-related information from a user;
generating, based on the obtained user-related information, a list of activities designed specifically for the user to perform;
performing, using a computing device of the user, at least one activity contained in the generated list of activities;
generating a result based on the at least one performed activity;
assigning a predetermined value to the generated result; and
accumulating the generated results for all performed activities on the list of activities.

9. The computer program product according to claim 8, wherein the generating the list of activities further comprises
generating, based on the obtained user-related information, at least one keyword indicative of at least one interest of the user;
searching, using the at least one generated keyword, a database of activities;
matching at least one activity contained in the database of activities with the at least one generated keyword; and,
generating the list of activities, wherein the list of activities contains activities matching the at least one generated keyword.

10. The computer program product according to claim 8, wherein the activity includes a challenge for the user to answer.

11. The computer program product according to claim 10, wherein a first predetermined value is assigned for participation of the user in the activity and a second predetermined value is assigned for the user's answer to the challenge included in the activity, wherein the generated result includes user's answer to the challenge included in the activity.

12. The computer program product according to claim 11, wherein the assigned predetermined value is a sum of the first predetermined value and the second predetermined value.

13. The computer program product according to claim 8, wherein the number of activities in the generated list of activities is limited.

14. The computer program product according to claim 8, wherein the operations further comprise
performing at least one activity that is not contained on the generated list of activities, wherein no value is assigned for a result generated based on the performed activity not contained on the generated list of activities.

15. A system comprising:
at least one programmable processor; and
a machine-readable medium storing instructions that, when executed by the at least one programmable processor, cause the at least one programmable processor to perform operations comprising:
obtaining user-related information from a user;
generating, based on the obtained user-related information, a list of activities designed specifically for the user to perform;
performing, using a computing device of the user, at least one activity contained in the generated list of activities;
generating a result based on the at least one performed activity;
assigning a predetermined value to the generated result; and
accumulating the generated results for all performed activities on the list of activities.

16. The system according to claim 15, wherein the generating the list of activities further comprises
generating, based on the obtained user-related information, at least one keyword indicative of at least one interest of the user;
searching, using the at least one generated keyword, a database of activities;
matching at least one activity contained in the database of activities with the at least one generated keyword; and,
generating the list of activities, wherein the list of activities contains activities matching the at least one generated keyword.

17. The system according to claim 15, wherein the activity includes a challenge for the user to answer.

18. The system according to claim 17, wherein a first predetermined value is assigned for participation of the user in the activity and a second predetermined value is assigned for the user's answer to the challenge included in the activity, wherein the generated result includes user's answer to the challenge included in the activity.

19. The system according to claim 18, wherein the assigned predetermined value is a sum of the first predetermined value and the second predetermined value.

20. The system according to claim 15, wherein the operations further comprise
performing at least one activity that is not contained on the generated list of activities, wherein no value is assigned for a result generated based on the performed activity not contained on the generated list of activities.
